(19) United States
(12) Patent Application Publication
(10) Pub. No.: US 2024/0096098 A1
(43) Pub. Date: Mar. 21, 2024

(54) SYSTEMS AND METHODS FOR FEATURE ACTIVATION

(71) Applicant: Apple Inc., Cupertino, CA (US)

(72) Inventor: Nicholas G. SAMPLE, Broomfield, CO (US)

(21) Appl. No.: 18/361,465

(22) Filed: Jul. 28, 2023

Related U.S. Application Data
(60) Provisional application No. 63/375,748, filed on Sep. 15, 2022.

(51) Int. Cl. G06V 20/50; G06T 7/20; G06T 7/50; G06T 7/70

(52) U.S. Cl. CPC G06V 20/50; G06T 7/20; G06T 7/50; G06T 7/70; G06T 2207/10028

(57) ABSTRACT

In some embodiments, an electronic device presents indications to a user in accordance with sensor data. The sensor data is optionally obtained by one or more sensors of the electronic device. In some embodiments, the electronic device detects a context in which the electronic device is operating. In some embodiments, the electronic device selectively activates and deactivates indication features in accordance with the context in which the electronic device is operating. For example, in certain contexts, the electronic device forgoes presenting indications that would be presented in other contexts.

### CROSS-REFERENCE TO RELATED APPLICATIONS

This application claims the benefit of U.S. Provisional Application No. 63/375,748, filed Sep. 15, 2022, the content of which is incorporated herein by reference in its entirety for all purposes.

### FIELD OF THE DISCLOSURE

Aspects of the present disclosure relate to systems and methods for selectively activating and deactivating indication features in accordance with the context in which an electronic device is operating.

### BACKGROUND OF THE DISCLOSURE

Electronic devices may present audio, visual, and/or tactile indications to users. One or more of these features may be more appropriate under certain device usage scenarios.

### SUMMARY OF THE DISCLOSURE

In some embodiments, an electronic device presents indications to a user in accordance with sensor data. The sensor data is optionally obtained by one or more sensors of the electronic device. In some embodiments, the electronic device detects a context in which the electronic device is operating. In some embodiments, the electronic device selectively activates and deactivates indication features in accordance with the context in which the electronic device is operating. For example, in certain contexts, the electronic device forgoes presenting indications that would be presented in other contexts.

While the foregoing and additional implementations are described herein, still other implementations are possible. Modifications within the spirit and scope of the presently disclosed technology are possible. Accordingly, the drawings and detailed description are to be regarded as illustrative in nature.

### BRIEF DESCRIPTION OF THE DRAWINGS

For a better understanding of the various described embodiments, reference should be made to the Detailed Description below, in conjunction with the following drawings in which like reference numerals often refer to corresponding parts throughout the figures.

FIG. 1A illustrates an example of a first device sensing data that does not cause the first device to present an indication to the user in accordance with some embodiments.

FIG. 1B illustrates an example of the first device sensing data that causes the first device to present an indication to the user in accordance with some embodiments.

FIG. 1C illustrates an example of the first device operating in a context that causes the first device to forgo presenting an indication in accordance with some embodiments.

FIG. 2 illustrates a block diagram of an example electronic device in accordance with some embodiments.

FIG. 3 illustrates an exemplary method for selective feature activation in accordance with some embodiments.

### DETAILED DESCRIPTION

In some embodiments, an electronic device presents indications to a user in accordance with sensor data. The sensor data is optionally obtained by one or more sensors of the electronic device. In some embodiments, the electronic device detects a context in which the electronic device is operating. In some embodiments, the electronic device selectively activates and deactivates indication features in accordance with the context in which the electronic device is operating. For example, in certain contexts, the electronic device forgoes presenting indications that would be presented in other contexts.

While some embodiments of the disclosure are described above and herein, additional and alternative embodiments are possible. Example embodiments are provided in the drawings and detailed description and are illustrative in nature. Modifications to the example embodiments are possible without departing from the scope of the disclosure.

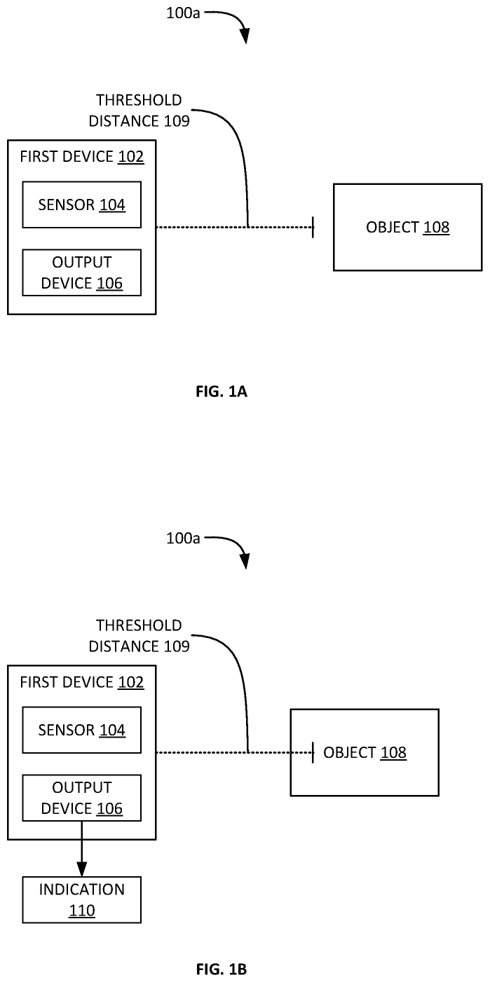

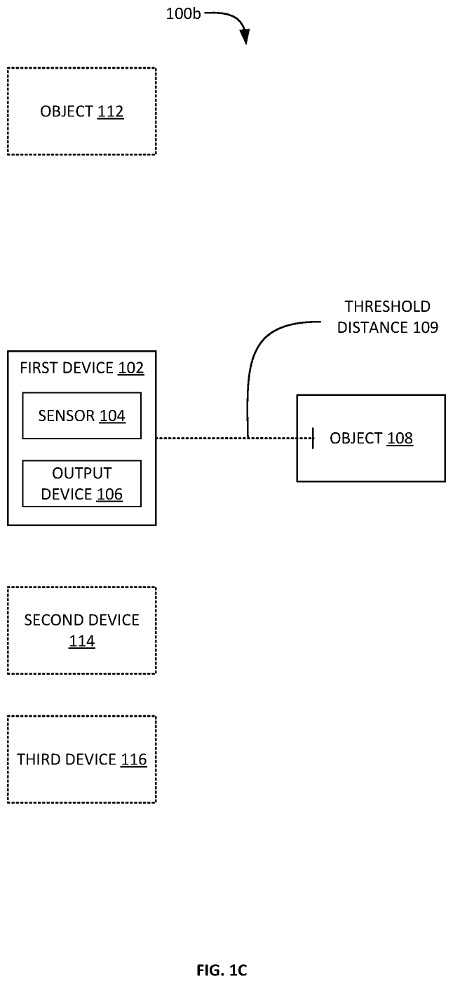

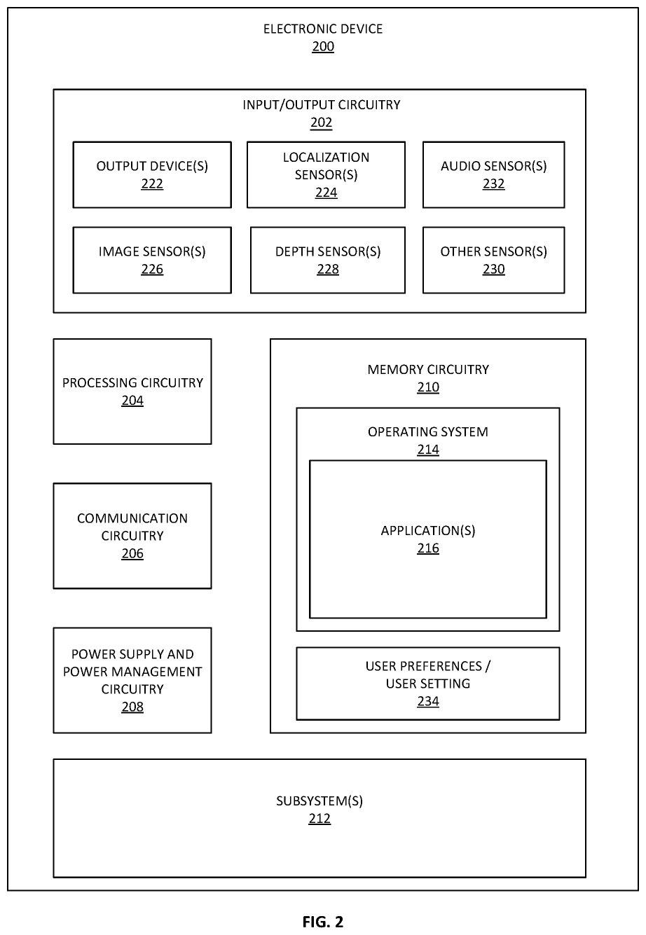

FIG. 1A illustrates an example of a first device 102 sensing data that does not cause the first device to present an indication to the user in accordance with some embodiments. In some embodiments, the first device 102 includes a sensor 104 and an output device 106. In some embodiments, the first device 102 includes additional sensors and/or additional output devices. In some embodiments, the sensor 104 is a proximity sensor, camera, range sensor, LIDAR, and/or depth sensor configured to sense objects in the environment of the first device 102, including object 108. In some embodiments, output device 106 is a display device, an indicator light, an audio output device (e.g., a speaker), or a tactile output device.

In some embodiments, the first device 102 detects a context 100a in which the first device 102 is operating. As described in more detail below with reference to FIGS. 1B-1C, in some contexts, the first device 102 generates indications in accordance with sensor data sensed by sensors 104, but in other contexts, the first device 102 forgoes presenting the indications in accordance with the sensor data. In some embodiments, the first device 102 determines the context 100a in which the first device 102 is operating using the sensor 102 used to determine whether indications should be generated, using one or more other sensors of the first device 102, and/or based on information received from other electronic devices in communication with the first device 102. In some embodiments, the context 100a of the first device 102 in FIG. 1A is a context in which the first device 102 presents indications using output device 106 in accordance with data sensed by sensor 104.

The first device 102 may use sensor 104 to collect sensor data indicative of events about which a user may wish to be notified. For example, the sensor 104 senses data that indicates distances between the first device 102 and objects in the environment of the first device 102 so that the first device 102 is able to generate an indication in response to detecting an object within a threshold distance 109 of the first device 102. In some embodiments, the indication is presented using the output device 106, and is optionally one or more of a visual, audio, or tactile indication.

As shown in FIG. 1A, object 108 is further than the threshold distance 109 from the first device 102. In some embodiments, sensor 104 detects that there are no objects within the threshold distance 109 of the first device 102. In some embodiments, the sensor 104 detects the distance between the first device 102 and the object 108 and the first device 102 determines that the object 108 is greater than the threshold distance 109 from the first device 102. In some embodiments, the sensor 104 does not detect the object 108, optionally because the distance between the object 108 and the first device 102 is greater than a range of the sensor 104. In some embodiments, because the data sensed by sensor 104 does not indicate an object within the threshold distance 109 of the first device 102, the first device 102 forgoes presenting an indication using the output device 106. For example, the first device 102 is in communication with or integrated with a vehicle and the threshold distance is 1, 5, 10, or 50 centimeters or 1, 2, or 3 meters.

FIG. 1B illustrates an example of the first device 102 sensing data that causes the first device to present an indication 110 to the user in accordance with some embodiments. In FIG. 1B, the first device 102 operates in the context 100a in which the first device 102 presents indications in accordance with data sensed by sensor 104. For example, the sensor 104 detects object 108 within the threshold distance 109 of the first device 102 while operating in context 100a. In this example, in accordance with the sensed data, the first device 102 generates an indication 110 using output device 106. In some embodiments, the indication 110 notifies the user that there is an object (e.g., object 108) within the threshold distance 109 of the first device 102.

The first device 102 may be one of several possible types of electronic devices. For example, first device 102 may be a mobile device (e.g., a smartphone, a tablet, a wearable device, a vehicle system) or a personal computer (e.g., a desktop computer or laptop computer). In some embodiments, the first device 102 is integrated with or in communication with an object, such as a building (e.g., a building security system or a smart home system) or vehicle (e.g., a bicycle, a motorcycle, an automobile, a watercraft, or an aircraft or an onboard computer thereof).

In some embodiments, the indication 110 is an audio indication, a visual indication, and/or a tactile indication. Example audio indications include beeps, pulses, music, tones or other non-verbal sounds and verbal indications, such as a voice speaking an alert that there is an object within the threshold distance 109 of the first device 102. Example visual indications include displayed text and/or images, such as text reading an alert that there is an object within the threshold distance 109 of the first device 102 or a predefined icon indicating that there is an object within the threshold distance 109 of the first device 102. Example tactile indications include haptics and/or vibrations. In some embodiments, the first device 102 presents multiple types (e.g., audio, visual, or tactile) of indications concurrently.

In some embodiments, the context 100a includes a location of the first device 102, identification of one or more objects (e.g., including object 108) in the vicinity of the first device 102, movement speed of the first device 102, and/or a physical arrangement of other electronic devices in the environment of the first device 102. In some embodiments, additional or alternative characteristics for evaluating the context of the first device 102 are possible, such as additional or alternative characteristics of the environment of the first device 102 and/or additional or alternative operations or characteristics of operations being concurrently performed by the first device 102. In some embodiments, the first device 102 additionally or alternatively determines context based on information received from other electronic devices.

For example, the first device 102 is in communication with or integrated with a vehicle (e.g., bicycle, motorcycle, automobile, aircraft, or watercraft) and context 100a is a context in which the first device 102 is moving using a throughway (e.g., road, airway, or waterway). In some embodiments, in this context 100a, the first device 102a produces an indication 110 in accordance with a determination that data sensed by sensor 104 indicates an object 108 within the threshold distance 109 of the first device 102. In FIG. 1A, the first device 102 operates in the same context 100a, but does not produce the indication 110 because the data sensed by sensor 104 does not indicate an object (e.g., object 108 or other object(s)) within the threshold distance 109 of the first device 102.

FIG. 1C illustrates an example of the first device 102 operating in a context 100b that causes the electronic device to forgo presenting an indication in accordance with some embodiments. As shown in FIG. 1C, the object 108 is within the threshold distance 109 of the first device 102, for example. In some embodiments, if the first device 102 were in the context 100a from FIGS. 1A-1B, the first device 102 would produce an indication 110 shown in FIG. 1B in response to detecting the object 108 within the threshold distance 109 of the first device 102. In some embodiments, while the first device 102 is operating in context 100b, the first device 109 forgoes producing the indication even though the sensor 104 detects the object 108 within the threshold distance 109.

In some embodiments, context 100b is identified based on one or more of the characteristics described above with reference to context 100a of FIGS. 1A-1B. For example, the first device 102 determines context 100b based on one or more of a movement speed of the first device 102, a location of the first device 102, identification of an object 112 (and/or object 108) in the physical environment of the first device 102, and/or identification of a physical arrangement of second device 114 and third device 116 in the physical environment of the first device 102.

For example, the first device 102 is integrated with or in communication with a vehicle and detects, using sensor 104, when objects are within the threshold distance 109 of the first device 102 to provide indications to the user of objects that are within the threshold distance 109 of the first device 102. These indications help identify proximate objects in some situations. In some situations, such as when the first device 102 is operating in context 100b as shown in FIG. 1C, it may be common for objects to be within the threshold distance 109 of the first device 102, triggering indications that are considered false positives. Selectively activating and deactivating the indications enhances user interactions with the first device 102 by providing a feature in contexts in which it is beneficial and not providing the feature in contexts in which it is not beneficial, for example.

For example, context 100b corresponds to the first device 102 being in a home garage. In this example, the first device 102 may determine, based on movement speed, location data (e.g., association of GPS location with the home), identification of object 112 (e.g., an object associated with the home garage), and/or identification of the arrangement of the second device 114 and/or third device 116 (e.g., devices associated with other vehicles stored in the home garage) that the context 100b of the first device 102 is the home garage. For example, indications of objects within the threshold distance 109 of the first device 102 may not be needed in context 100b of the home garage because the user may typically park the vehicle within the threshold distance 109 of an object 108 in the home garage. As another example, the first device 102 may use a different (e.g., smaller) threshold distance for generation of indications while operating in context 100b.

As another example, context 100b corresponds to the first device 102 operating near a drive-through window at a restaurant. In this example, the first device 102 may determine, based on movement speed, location data (e.g., correspondence of map data corresponding to the restaurant and GPS location of device 102), identification of object 112 (e.g., an object associated with the drive-through window of the restaurant), and/or identification of the arrangement of the second device 114 and/or third device 116 (e.g., scene understanding including identification of other vehicles in line at the drive-through window of the restaurant) that the context 100b of the first device 102 is the drive-through window of the restaurant. For example, indications of objects within the threshold distance 109 of the first device 102 may not be needed in context 100b of the drive-through window of the restaurant because vehicles and other objects (e.g., the building of the restaurant, the drive-through menu, the ordering intercom, and/or other vehicles) may typically be within the threshold distance 109 of the first device 102 while in the context 100b of the drive-through window of the restaurant. As another example, the first device 102 may use a different (e.g., smaller) threshold distance for generation of indications while operating in context 100b.

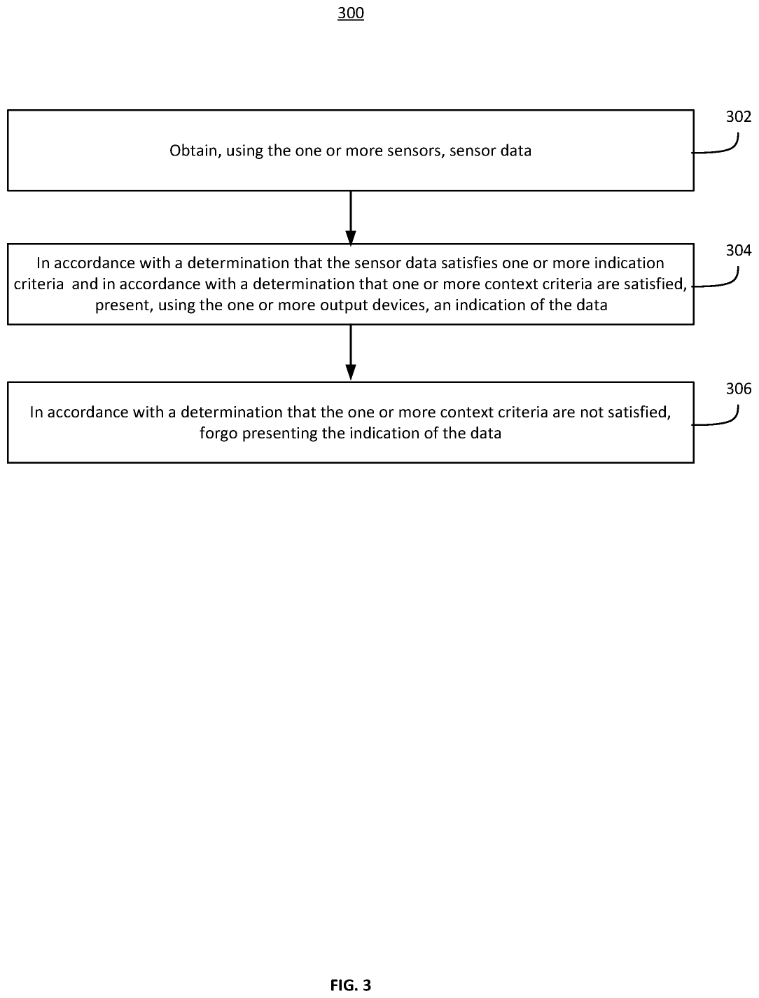

FIG. 2 illustrates a block diagram of an example electronic device 200 in accordance with some embodiments. Electronic device 200 can represent first device 102 in FIGS. 1A-1C, second device 114 in FIG. 1C, and/or third device 116 in FIG. 1C shown in more detail. It is understood that the block diagram of FIG. 2 includes one example architecture, but that a different electronic device may have more or fewer components and/or a different configuration of components than shown in FIG. 2. For instance, one or more of electronic device(s) 102, 114, and/or 116 may include additional components not illustrated in FIG. 2 and/or may exclude one or more components illustrated in FIG. 2. Various components of FIG. 2 can be implemented in hardware, software, firmware or combinations thereof.

As illustrated, FIG. 2 can include input/output circuitry 202, processing circuitry 204, communication circuitry 206, power supply and power management circuitry 208, memory circuitry 210 and one or more subsystems 212. Although not shown in FIG. 2, the various components can be electrically coupled by one or more buses and/or using one or more interfaces and electrical connections.

Input/output circuitry 202 can include devices for providing input to the electronic device 200 and for providing output from the electronic devices. In some examples, input/output circuitry 202 can include sensors such as localization sensor(s) 224, image sensor(s) 226, depth sensor(s) 228, audio sensor(s) 232, and other sensor(s) 230 and/or one or more output device(s) 222. In some embodiments, sensor 104 in FIGS. 1A-1C corresponds to localization sensor(s) 224, image sensor(s) 226, depth sensor(s) 228, audio sensor(s) 232, and/or other sensor(s) 230 in FIG. 2. In some embodiments, the first device 102 uses one or more of localization sensor(s) 224, image sensor(s) 226, depth sensor(s) 228, audio sensor(s) 232, and other sensor(s) 230 to sense sensor data (e.g., to determine whether an object is within the threshold distance 109 in FIGS. 1A-1C) and/or to determine the context (e.g., context 100a in FIGS. 1A-1B or context 100b in FIG. 1C) in which the first device 102 is operating.

Output device(s) 222 can include display device(s), speaker(s), and/or haptic output devices in communication with or integrated with electronic device 200 that provide visual, audio, and/or tactile feedback, respectively, to the user. For example, output device(s) 222 in FIG. 2 includes output device 106 in FIGS. 1A-1C and produces indication 110 shown in FIG. 1B. Localization sensor(s) 224 may be used to determine location, heading, and/or orientation of electronic device 200. The localization sensor(s) 224 or localization system(s) can include global navigation satellite system (GNSS) or sensor, inertial navigation system (INS) or sensor, global positioning system (GPS) or sensor, altitude and heading reference system (AHRS) or sensor, compass, etc. Image sensor(s) 226 and depth sensor(s) 228 can include sensors to generate two-dimensional or three-dimensional images, radio detection and ranging sensors or systems, light detection and ranging sensors or systems, visual or video detection and ranging sensors or systems, infrared (IR) sensors, optical sensors, camera sensors (e.g., color or grayscale), etc. Audio sensor(s) 232 can include one or more microphones, optionally arranged in an array. It is understood that additional input/output devices can be included in the electronic devices described herein, such as a keyboard, a mouse, a button, a slider, a touch sensor or touch sensor panel, a wheel, a touchpad, a trackpad, a touch screen, a joystick, a proximity sensor, a switch, etc.

Processing circuitry 204 can include one or more processors including microcontrollers, microprocessors, application specific integrated circuits (ASICs), programmable logic device (PLD), field-programmable gate arrays (FPGAs), central processing units (CPUs), graphics processing units (GPUs), digital signal processors (DSPs), or any suitable processing circuitry. Processing circuitry 204 can be used to perform any of the processes, methods, or functions described herein (e.g., optionally by executing instructions or programs stored in a non-transitory computer-readable storage medium). Some example functions include receiving user inputs, communicating with other electronic devices, sensing data, generating indications and/or determining the context in which the electronic device is operating.

Communication circuitry 206 can include circuitry to provide for wired or wireless communication with other electronic devices, such as between electronic devices 102a, 114, and/or 120 included in system 100. In some examples, the communication circuitry can enable communication using different communication protocols such as WiFi, Bluetooth, Zigbee, cellular, satellite, etc. In some examples, the communication circuitry can include one or more transmitter and/or receiver antennas to transmit and/or receive data from one or more data sources for use in predictive actions as described herein.

In some examples, power supply and power management circuitry 208 can include one or more energy storage device(s) (e.g., a battery or multiple batteries) to provide a power supply for the powered components of electronic device 200. In some examples, power supply and power management circuitry 208 can include circuitry for wired or wireless charging of the one or more energy storage device(s). In some examples, the power supply and power management circuitry 208 can include circuitry to manage power delivery and usage by the components of electronic device 200, to manage charging of the one or more energy storage device(s), and/or to monitor the energy levels of the one or more energy storage devices.

Memory circuitry 210 can include any suitable type of memory including but not limited to volatile or non-volatile memory (e.g., where data may be maintained after all power is removed from electronic device 200). Memory circuitry 210 can include any suitable electronic, magnetic, optical, electromagnetic, infrared, or semiconductor system, apparatus or device. The memory circuitry can include, but is not limited to, flash memory devices, random access memory (RAM) devices (e.g., dynamic random-access memory (DRAM), static random-access memory (SRAM), double-data-rate random-access memory (DDR RAM), or other high-speed RAM or solid-state RAM, etc.), read-only memory (ROM) devices, or erasable or electrically erasable programmable read-only memory devices (EPROM or EEPROM). In some examples, some of memory circuitry 210 can be integrated within other components of electronic device 200. In some examples, memory circuitry 210 can be separate from the one or more other components of electronic device 200 and electrically coupled for read and/or write operations.

In some examples, the memory circuitry 210 or a subset of the memory circuitry 210 can be referred as a computer-readable storage medium. Memory circuitry 210 and/or the non-transitory computer readable storage medium of memory circuitry 210 can store programs, instructions, data modules, data structures or a subset or combination thereof. In some examples, Memory circuitry 210 and/or the non-transitory computer readable storage medium can store an operating system 214. In some examples, the operating system 214 can manage one or more running applications 216 (e.g., by scheduling the electronic device 200 to execute the applications 216 using one or multiple processing cores). Additionally, memory circuitry 210 and/or non-transitory computer readable storage medium can have programs/instructions stored therein, which when executed by processing circuitry, can cause the electronic device 200 (or the computing system more generally) to perform one or more functions and methods of one or more examples of this disclosure (e.g., determining whether or not to perform a maneuver and/or whether or not to update a movement algorithm of the device). As used herein, a “non-transitory computer-readable storage medium” can be any tangible medium (e.g., excluding signals) that can contain or store programs/instructions for use by the electronic device (e.g., processing circuitry).

Subsystems 212 can include any additional subsystems for electronic device 200. For some mobile devices, subsystems 212 can include, without limitation, motor controllers and systems, additional or alternative actuators, light systems, navigation systems, entertainment systems, and the like.

FIG. 3 illustrates an exemplary method 300 for selective feature activation in accordance with some embodiments. Method 300 is described below as being performed by first device 102, but it should be understood that, in some embodiments, second device 114, third device 116, and/or electronic device 200 perform method 300. In some embodiments, one or more steps of method 300 are stored using a non-transitory computer readable storage medium. In some embodiments, one or more steps of method 300 are re-ordered, modified, and/or omitted without departing from the scope of the disclosure. Moreover, in some embodiments, additional and/or alternative steps for method 300 are possible without departing from the scope of the disclosure.

In some embodiments, first device 102 obtains 302, using the one or more sensors (e.g., sensor 104), sensor data. In some embodiments, in accordance with a determination that the sensor data satisfies one or more indication criteria and in accordance with a determination that one or more context criteria are satisfied, the first device 102 presents 304, using the one or more output devices (e.g., output device 106), an indication (e.g., 110) of the data. For example, the sensor data satisfies one or more indication criteria when the first device 102 detects the object 108 within the threshold distance 109 of the first device 102 in FIG. 1B. In some embodiments, the first device 102 determining that the one or more context criteria are satisfied corresponds to the first device 102 determining that it is operating in context 100a, as shown in FIG. 1B. In some embodiments, in accordance with a determination that the one or more context criteria are not satisfied, the first device 102 forgoes 306 presenting the indication of the data. For example, the first device 102 determining that the one or more context criteria are not satisfied corresponds to the first device 102 determining that it is operating in context 100b, as shown in FIG. 1C.

In some embodiments, the one or more sensors (e.g., sensor 104) include a proximity sensor or a depth sensor and the one or more indication criteria include a criterion that is satisfied when the proximity sensor or the depth sensor detects an object (e.g., object 108) within a predefined threshold distance (e.g., threshold distance 109) of the electronic device (e.g., first device 102). For example, in FIG. 1B, the first device 102 determines that object 108 is within the threshold distance 109 of the first device 102 and presents indication 110.

In some embodiments, the one or more context criteria include a criterion that is satisfied based on a current location of the electronic device (e.g., first device 102). For example, the first device 102 is in different locations while operating in context 100a in FIG. 1A or 1B and while operating in context 100b in FIG. 1C.

In some embodiments, the one or more sensors (e.g., sensor 104) include one or more cameras, and the one or more context criteria include a criterion that is satisfied based on identifying an object (e.g., object 112) included in an image of current surroundings of the electronic device (e.g., first device 102) captured using the one or more cameras. For example, the first device 102 identifies context 100b in FIG. 1C based on capturing an image of object 112, object 108, second device 114, and/or third device 116 in the physical environment of the first device 102. In some embodiments, the first device 102 uses machine learning techniques, such as scene understanding, to evaluate the one or more context criteria and/or identify context 100a or 100b based on one or more captured images of the physical environment of the first device 120.

In some embodiments, the one or more context criteria include a criterion that is satisfied based on a speed of movement of the electronic device. For example, the speed of movement of the first device 102 in FIGS. 1A-1B while operating in context 100a is different from the speed of movement of the first device 102 in FIG. 1C while operating in context 100b.

In some embodiments, the one or more context criteria include a criterion that is satisfied based on detecting a physical arrangement of one or more other electronic devices (e.g., second device 114 and/or third device 116) in the physical environment of the electronic device (e.g., first device 120). For example, the first device 120 identifies context 100b based on identifying the physical arrangement of second device 114 and/or third device 116 in the physical environment of the first device 102.

In some embodiments, in accordance with a determination that the data do not satisfy the one or more indication criteria, the first device 102 forgoes presenting the indication of the data. For example, in FIG. 1A, the first device 102 does not present an indication because the object 108 is not within the threshold distance 109 of the first device 102.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented. The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer).

Technology implementors are reminded that the collecting sensor data in the physical environment of the electronic device should be performed in accordance with privacy practices meeting or exceeding applicable laws and/or industry standards. These privacy practices may include, but are not limited to, requiring user permission to share the data and/or permitting the user to opt-out of processing and/or storing some or all of the data and/or anonymizing the data, and so forth. For example, implementers of devices may explain in its user interface and documentation the devices ability to sense data, and require appropriate parties to opt-in before accepting incoming data sensing requests.

1. An electronic device comprising:
one or more sensors;
one or more output devices;
memory; and
one or more processors coupled to the one or more sensors, the one or more output devices, and the memory, the one or more processors configured to:
obtain, using the one or more sensors, sensor data;
in accordance with a determination that the sensor data satisfies one or more indication criteria and in accordance with a determination that one or more context criteria are satisfied, present, using the one or more output devices, an indication of the sensor data; and
in accordance with a determination that the one or more context criteria are not satisfied, forgo presenting the indication of the sensor data.

2. The electronic device of claim 1, wherein the one or more sensors include a proximity sensor or a depth sensor and the one or more indication criteria include a criterion that is satisfied when the proximity sensor or the depth sensor detects an object within a predefined threshold distance of the electronic device.

3. The electronic device of claim 1, wherein the one or more context criteria include a criterion that is satisfied based on a current location of the electronic device.

4. The electronic device of claim 1, wherein the one or more sensors include one or more cameras, and the one or more context criteria include a criterion that is satisfied based on identifying an object included in an image of current surroundings of the electronic device captured using the one or more cameras.

5. The electronic device of claim 1, wherein the one or more context criteria include a criterion that is satisfied based on a speed of movement of the electronic device.

6. The electronic device of claim 1, wherein the one or more context criteria include a criterion that is satisfied based on detecting a physical arrangement of one or more other electronic devices in a physical environment of the electronic device.

7. The electronic device of claim 1, wherein the one or more processors are further configured to:
in accordance with a determination that the sensor data do not satisfy the one or more indication criteria, forgo presenting the indication of the sensor data.

8. A method performed at an electronic device including one or more sensors, one or more output devices, memory, and one or more processors coupled to the one or more sensors, the one or more output devices, and the memory, the method comprising:
obtaining, using the one or more sensors, sensor data;
in accordance with a determination that the sensor data satisfies one or more indication criteria and in accordance with a determination that one or more context criteria are satisfied, presenting, using the one or more output devices, an indication of the sensor data; and
in accordance with a determination that the one or more context criteria are not satisfied, forgoing presenting the indication of the sensor data.

9. The method of claim 8, wherein the one or more sensors include a proximity sensor or a depth sensor and the one or more indication criteria include a criterion that is satisfied when the proximity sensor or the depth sensor detects an object within a predefined threshold distance of the electronic device.

10. The method of claim 8, wherein the one or more context criteria include a criterion that is satisfied based on a current location of the electronic device.

11. The method of claim 8, wherein the one or more sensors include one or more cameras, and the one or more context criteria include a criterion that is satisfied based on identifying an object included in an image of current surroundings of the electronic device captured using the one or more cameras.

12. The method of claim 8, wherein the one or more context criteria include a criterion that is satisfied based on a speed of movement of the electronic device.

13. The method of claim 8, wherein the one or more context criteria include a criterion that is satisfied based on detecting a physical arrangement of one or more other electronic devices in a physical environment of the electronic device.

14. A non-transitory computer readable storage medium storing instructions that, when executed by one or more processors of an electronic device that further includes one or more sensors, one or more output devices, and memory coupled to the one or more processors, cause the electronic device to:
obtain, using the one or more sensors, sensor data;
in accordance with a determination that the sensor data satisfies one or more indication criteria and in accordance with a determination that one or more context criteria are satisfied, present, using the one or more output devices, an indication of the sensor data; and
in accordance with a determination that the one or more context criteria are not satisfied, forgo presenting the indication of the sensor data.

15. The non-transitory computer readable storage medium of claim 14, wherein the one or more sensors include a proximity sensor or a depth sensor and the one or more indication criteria include a criterion that is satisfied when the proximity sensor or the depth sensor detects an object within a predefined threshold distance of the electronic device.

16. The non-transitory computer readable storage medium of claim 14, wherein the one or more context criteria include a criterion that is satisfied based on a current location of the electronic device.

17. The non-transitory computer readable storage medium of claim 14, wherein the one or more sensors include one or more cameras, and the one or more context criteria include a criterion that is satisfied based on identifying an object included in an image of current surroundings of the electronic device captured using the one or more cameras.

18. The non-transitory computer readable storage medium of claim 14, wherein the one or more context criteria include a criterion that is satisfied based on a speed of movement of the electronic device.

19. The non-transitory computer readable storage medium of claim 14, wherein the one or more context criteria include a criterion that is satisfied based on detecting a physical arrangement of one or more other electronic devices in a physical environment of the electronic device.

20. The non-transitory computer readable storage medium of claim 14, wherein the instructions further cause the electronic device to:
in accordance with a determination that the sensor data do not satisfy the one or more indication criteria, forgo presenting the indication of the sensor data.
